(19) United States
(12) Patent Application Publication
(10) Pub. No.: US 2006/0106651 A1
(43) Pub. Date: May 18, 2006

(54) Insurance claim monitoring

(75) Inventors: Bill Madison, Alpharetta, GA (US); Jeanne Trocheck, Roswell, GA (US); Stephen Gillard, Cumming, GA (US)

Correspondence Address: KING & SPALDING LLP, 1180 PEACHTREE STREET, ATLANTA, GA, 30309, US

(73) Assignee: ChoicePoint Asset Company, Wilmington, DE (US)

(21) Appl. No.: 11/261,302

(22) Filed: Oct. 29, 2005

Related U.S. Application Data
(60) Provisional application No. 60/623,596, filed on Oct. 29, 2004.
(60) Provisional application No. 60/657,278, filed on Mar. 1, 2005.

(51) Int. Cl. G06Q 40/00

(52) U.S. Cl. 705/4

(57) ABSTRACT

Automated generation and output of customized reports based on the insurance claim records of insured persons. Insurance carriers can automatically obtain customized reports for use in monitoring insured persons' insurance claim records for previously-unavailable claim information. Each insured person can be insured on a recently-executed insurance policy of an insurance carrier. An insurance carrier's customized report can include, for each insured person, claim information related to the insured person that was unavailable to the insurance carrier before execution of the insurance policy. The customized report can also include claim information related to the insured person that was unavailable before a specified period of time before execution of the insurance policy. The insurance carriers can designate the reports' format and content. Allowing insurance carriers to designate how, and in what format, they wish to receive the reports permits for more effective and more efficient monitoring of insured persons' claim records.

### RELATED PATENT APPLICATIONS

This patent application claims priority under 35 U.S.C. § 119 to U.S. Provisional Patent Application No. 60/623,596, entitled “Method and System for Insurance Claim monitoring,” filed Oct. 29, 2004, and U.S. Provisional Patent Application No. 60/657,278, entitled “Method and System for Evaluating Risk of Insuring an Individual Based on Timely Assessment of Motor Vehicle Records,” filed Mar. 1, 2005. The complete disclosure of the above-identified applications is hereby fully incorporated herein by reference.

### FIELD OF THE INVENTION

The invention relates generally to monitoring insured persons' insurance claim records and more particularly to the automated generation and output of customized reports based on the insurance claim records of insured persons.

### BACKGROUND OF THE INVENTION

Insurance carriers are in the business of risk analysis. When evaluating whether, for what price, and at what coverage level, to insure a potential customer, the insurance carriers must effectively evaluate both existing and potential risks. Among the ways in which insurance carriers evaluate the risk of insuring a potential customer is reviewing the potential customer's insurance claim history. The terms “insurance claim” and “claim” are used interchangeably herein to refer to a loss incurred and reported by an insured person to his or her respective insurance carrier.

The term “insurance carrier” is used herein to refer to a provider of insurance. For example, an insurance carrier can provide automobile, and/or property insurance. The term “insured person” is used herein to refer to any person insured by at least one insurance carrier.

Generally, the fewer insurance claims a potential insurance customer has had, the lower risk the potential customer presents to insurance carriers. Accordingly, a potential customer with fewer insurance claims generally will be granted greater insurance coverage, at a lower price, than a potential customer with more insurance claims.

To effectively evaluate a potential customer's insurance claim history, insurance carriers must identify each of the potential customer's previous insurance claims. Conventionally, insurance carriers have attempted to identify such claims by relying on information from the potential customers, interviewing the potential customers' previous insurance carriers, and conducting manual searches of local records. These conventional approaches generally are prohibitively time-consuming. In addition, they often paint incomplete pictures of the potential customers' insurance claim histories.

More recently, insurance carriers have attempted to identify potential customers' previous insurance claims by utilizing electronic databases comprising multiple insurance carriers' claim information (referred to herein as “claim databases”). For example, a Comprehensive Loss Underwriting Exchange (“C.L.U.E.”) database comprises multiple insurance carriers' auto insurance claim information. Each participating insurance carrier feeds its customers' auto insurance claim information into the CLUE database. When a first insurance carrier's customer applies for insurance coverage from a second insurance carrier, the second insurance carrier can access the CLUE database to learn of the customer's past claims.

Unfortunately, existing claim databases fail to comprise up-to-date claim information. The insurance carriers feed claim information to the databases only on a periodic basis—typically, on a monthly basis. As a result, if an insurance customer changes insurance carriers immediately after (or soon after) filing a claim, the new insurance carrier will be unaware of the claim. Therefore, the new insurance carrier will base its decisions of whether to insure the customer, at what price to insure the customer, and at what coverage level to insure the customer, on incomplete information.

State laws generally provide that, after entering into a new insurance policy with a new customer, an insurance carrier has a short period in which to cancel the policy or change the terms of the policy based on newly-discovered information (referred to herein as a “review period”). In the conventional art, insurance carriers are unable to determine whether previously-unavailable claim information exists regarding each new customer. Accordingly, the insurance carriers are unable to cancel policies or change policy terms based on the previously-unavailable claim information.

Thus, a need exists in the art for a system and method for monitoring insured persons' insurance claim records. Specifically, a need exists in the art for a system and method for efficiently monitoring insured persons' insurance claim records for previously-unavailable claim information. In addition, a need exists in the art for such systems and methods to output the information obtained in so monitoring the insured persons' claim records in a format that is desirable to an information recipient.

### SUMMARY OF THE INVENTION

The invention provides systems and methods for monitoring insured persons' claim records. Specifically, the invention provides systems and methods for generating and outputting customized reports based on the insurance claim records of insured persons. For example, insurance carriers can use the customized reports to monitor each insured person's insurance claim record for claim data that was unavailable to the insurance carriers at the time of executing an insurance policy with the insured person. According to pre-set designations of each insurance carrier, the customized reports can comprise information regarding the insured persons, the insured persons' insurance policies, and/or any previously-unavailable claim data for each insured person.

Discovering the existence and details of previously-unavailable claim data may allow insurance carriers to cancel and/or change the terms of existing customers' insurance policies. The cancellations and/or term changes can be based on more complete information regarding the existing customers' risk profiles.

In one aspect of the invention, a claim monitoring module can identify previously-unavailable claim data corresponding to an insured person insured on an insurance policy of a particular insurance carrier. The claim monitoring module can utilize claim data, policy data, and/or insured data to identify the previously-unavailable claim data.

An agent or agents of the insurance carrier can create the claim data. For example, they can create the claim data by obtaining the claim data from a claim data source and storing the claim data in a claim database.

The claim data comprises information regarding at least one insurance claim. For example, the claim data can comprise information regarding at least one auto insurance claim. For example, for each claim, the claim data can comprise information regarding the claim type, information regarding the claim loss amount, a name of an insured person corresponding to the claim, and a date on which the claim data was created.

The policy data comprises information regarding at least one insurance policy of the insurance carrier. For example, the policy data can comprise information regarding at least one auto insurance policy of the insurance carrier. For each insurance policy, the insured data comprises information regarding at least one person insured on the insurance policy. Thus, the insured data comprises information regarding the insured person. For example, the insured data can comprise a name of the insured person.

The claim monitoring module identifies any of the claim data that corresponds to the insured person by comparing the claim data to the policy data and/or the insured data. For example, the claim monitoring module can compare the name of the insured person, an address of the insured person, and/or a vehicle identification number (VIN) corresponding to the insured person to the claim data to determine whether the insured person corresponds to any of the claim data. For example, if the name of the insured person matches certain of the claim data, then the claim monitoring module can determine that the certain claim data corresponds to the insured person.

The claim monitoring module determines whether any identified claim data was unavailable to the insurance carrier during a specified time period comprising an execution date of an insurance policy corresponding to the insured person and the insurance carrier. In other words, the claim monitoring module determines whether any identified claim data was unavailable to the insurance carrier at or around the date on which the insurance carrier executed an insurance policy with the insured person. If any such previously-unavailable information exists, the insurance carrier may be able to cancel the insurance policy and/or change the terms of the insurance policy.

To determine whether any identified claim data was unavailable to the insurance carrier during the specified time period, the claim monitoring module first identifies policy data corresponding to the insurance carrier and the insured person. The policy data corresponds to an insurance policy between the insurance carrier and the insured person. Next, the claim monitoring module determines an execution date of the insurance policy. For example, if the policy data comprises the execution date, the claim monitoring module can determine the execution date by reviewing the policy data.

Next, the claim monitoring module determines a date on which the identified claim data was created. For example, the claim monitoring module can determine the date on which the identified claim data was created by reviewing the identified claim data. Finally, the claim monitoring module determines whether any identified claim data was unavailable to the insurance carrier during the specified time period by determine whether the date on which the identified claim data was created is within a specified number of days of the execution date of the insurance policy. If the date on which the identified claim data was created is within a specified number of days of the execution date of the insurance policy, then the identified claim data was unavailable to the insurance carrier during the specified time period.

In another aspect of the invention, the claim monitoring module can generate a report comprising information regarding whether the identified claim data was unavailable to the insurance carrier during the specified time period. For example, the claim monitoring module can apply rule data designating the format of the report and/or the content of the report to the policy data, insured data, and/or claim data to generate the report. A report recipient, such as the insurance carrier, can create at least a portion of the rule data.

These and other aspects, objects, features, and advantages of the invention will become apparent to a person skilled in the art upon consideration of the following detailed description of illustrated exemplary embodiments, which include the best mode of carrying out the invention as presently perceived.

### BRIEF DESCRIPTION OF THE DRAWINGS

FIG. 1 is a block diagram depicting a system for generating and outputting customized reports based on the insurance claim records of insured persons, according to an exemplary embodiment of the invention.

FIG. 2 is a block diagram depicting a control module of a system for generating and outputting customized reports based on the insurance claim records of insured persons, according to an exemplary embodiment of the invention.

FIG. 3 is a flow chart depicting a method for generating and outputting customized reports based on the insurance claim records of insured persons, according to an exemplary embodiment of the invention.

FIG. 4 is a flow chart depicting a method for generating a report based on the insurance claim record of an insured person, according to an exemplary embodiment of the invention.

FIG. 5 is a flow chart depicting a method for generating a claim monitoring report, according to an exemplary embodiment of the invention.

FIG. 6 is a block diagram depicting a claim monitoring report generated in accordance with an exemplary embodiment of the invention.

### DETAILED DESCRIPTION OF EXEMPLARY EMBODIMENTS

The invention is directed to automated generation and output of customized reports based on the insurance claim records of insured persons. In particular the invention is directed to monitoring insured persons' insurance claim records for previously-unavailable claim information and generating and outputting reports based on the monitoring results. Discovering the existence and details of previously-unavailable claim information may allow insurance carriers to cancel and/or change the terms of existing customers' insurance policies. The cancellations and/or term changes can be based on more complete information regarding the existing customers' risk profiles.

According to pre-set designations of each insurance carrier, the customized reports can comprise information regarding the insured persons, the insured persons' insurance policies, and/or any previously-unavailable claim information for each insured person. For example, the insurance carriers can designate the reports' format and content. Allowing insurance carriers to designate how, and in what format, they wish to receive the reports permits for more effective and more efficient monitoring of insured persons' claim records.

The term “report” is used herein to refer to any data and/or output created in accordance with an exemplary embodiment of the present invention. For example, a report can comprise comprehensive information regarding previously-unavailable claim information. Alternatively, the report can comprise an acknowledgment that the system failed to find any pertinent information.

The invention comprises a computer program that embodies the functions described herein and illustrated in the appended flow charts. However, it should be apparent that there could be many different ways of implementing the invention in computer programming, and the invention should not be construed as limited to any one set of computer program instructions. Further, a skilled programmer would be able to write such a computer program to implement an embodiment of the disclosed invention based on the flow charts and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

Turning now to the drawings, in which like numerals indicate like elements throughout the figures, exemplary embodiments of the invention are described in detail.

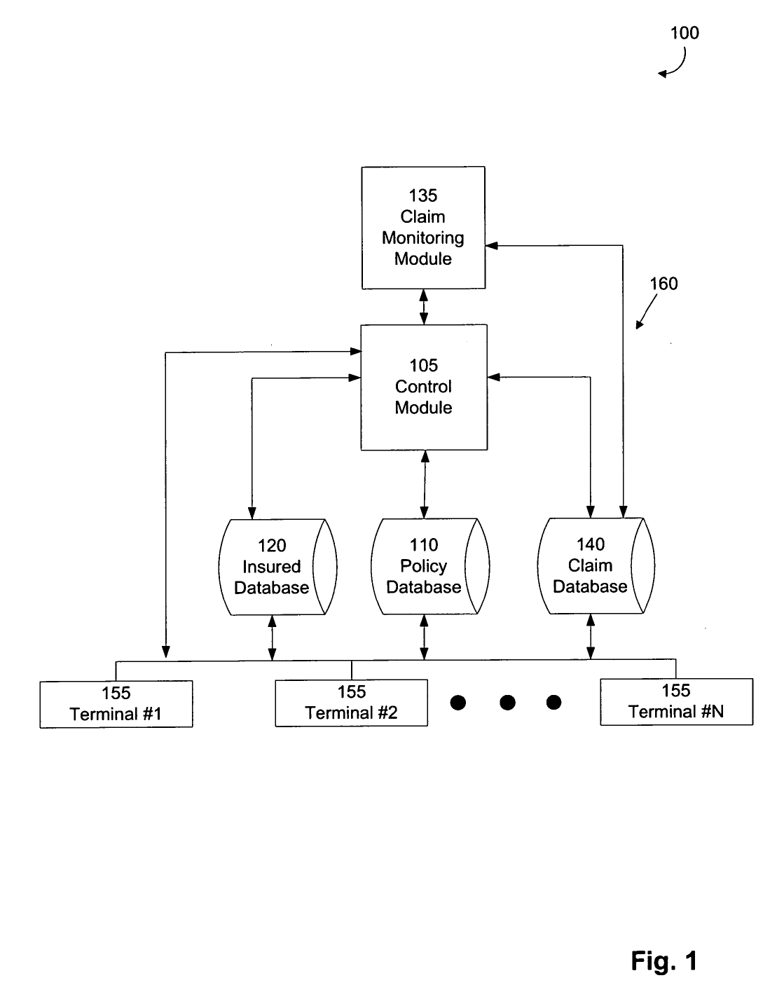

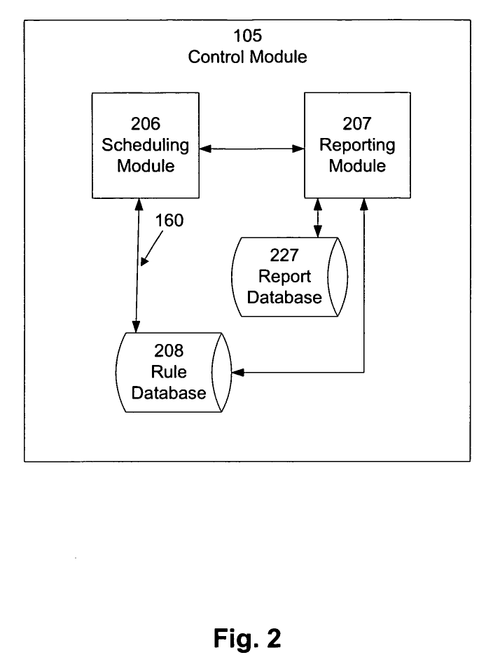

An exemplary system for generating and outputting customized reports based on the insurance claim records of insured persons will now be described with reference to FIGS. 1-2. FIG. 1 is a block diagram depicting a system 100 for generating and outputting customized reports based on the insurance claim records of insured persons, according to an exemplary embodiment of the invention. FIG. 2 is a block diagram depicting a control module 105 of the system 100, according to an exemplary embodiment of the invention. A person skilled in the art will appreciate that FIGS. 1-2 and the associated discussion are intended to provide a general description of representative computer devices and program modules for implementing the exemplary embodiment.

The exemplary system 100 comprises an arrangement of computer-based components coupled to one another through a set of data links 160 such as a network 160. While some of the system's functions are implemented in a single system component, other functions are dispersed among components. The information structure of the system 100 offers a distributed computing environment. In this environment, the code behind the software-based process steps does not necessarily execute in a singular component; rather, the code can execute in multiple components of the system 100.

The system's communication network 160, a set of data links 160, facilitates information flow between the components. For a system 100 in which all components are located at the same site, a local area network can provide the backbone for the system's communication network 160. In a system 100 with geographically dispersed components, the communications network 160 can comprise a wide area network, a virtual network, a satellite communications network, or other communications network elements as are known in the art.

In an exemplary application of the system 100, at least one insurance carrier's policy data is stored in a policy database 110. The policy data comprises each insurance carrier's insurance policy information, such as: (1) the insurance carrier's A.M. Best number (a carrier-specific numerical identifier); (2) the insurance carrier's National Association of Insurance Commissioners (“NAIC”) number (a carrier-specific numerical identifier); (3) a PIN number for each person insured by the insurance carrier; (4) a designation, for each policy, of which insured person is the primary policyholder; (5) the type of insurance (e.g., auto or property) provided for under each insurance policy; (6) each insurance policy's policy type, including, e.g., whether the insurance policy is for full (comprehensive) coverage, collision, bodily injury, property damage, catastrophe damage, and/or liability, and the amounts and types of reimbursement provided for under the policy; (7) each insurance policy's insurance inception date (i.e., the date the policy was written and/or executed); (8) each insurance policy's most recent policy period begin date; (9) each insurance policy's policy period end date; (10) the vehicle identification number of each vehicle, if any, insured on each policy; and/or (11) the vehicle make, model, and model year for each vehicle, if any, insured on each insurance policy.

In one embodiment of the invention, the insurance carrier(s) and/or an agent or agents of the insurance carrier(s) can store the policy data in the policy database 110. For example, the insurance carrier(s) and/or agent(s) can access the policy database 110 via a terminal 155. The terminal 155 can be any device through which data or information can be entered or displayed.

The term “agent” is used herein to refer to any person or entity operating on behalf of an insurance carrier or authorized to take any action on behalf of an insurance carrier.

Similarly, insured data of the insurance carrier(s) is stored in an insured database 120. The insured data comprises information regarding persons insured by the insurance carrier(s). For example, the insured data can comprise: (1) the name of each insured person; (2) the address of each insured person; (3) the date of birth of each insured person; (4) one or more PIN numbers for each insured person; (5) the social security number of each insured person; (6) the A.M. Best number of each insurance carrier that provides insurance to each insured person; (7) the driver's license number of each (licensed) insured person; and/or (8) the driver's license state of each licensed (insured) person.

In one embodiment of the invention, the insurance carrier(s) and/or an agent or agents of the insurance carrier(s) can store the insured data in the insured database 120. For example, the insurance carrier(s) and/or agent(s) can access the insured database 120 via the terminal 155.

Rule data is stored in a rule database 208 of a control module 105. The rule data comprises each report recipient's (e.g., each insurance carrier's) preferences, and internal rules, for the operation of an exemplary embodiment of the invention. For example, the report recipient preferences can include: (1) the insured person(s) and/or insurance policy(ies) regarding which to generate each report; (2) what information to include in each report; (3) the format of each report; (4) when to generate each report; (5) how long, if at all, to store each report in a data storage medium; and/or (6) when to output each report.

In one embodiment of the invention, the report recipient preferences can depend on information retrieved by the system 100 in generating the report(s). For example, the report recipient can designate specific formatting and content preferences that depend on whether the system 100 identifies any previously-unavailable claim information. If the system 100 identifies any previously-unavailable claim information, for example, the report recipient may desire a detailed report. Alternatively, if the system 100 fails to identify any previously-unavailable claim information, the report recipient may desire to receive only a succinct report or may even desire not to receive any report. In one embodiment of the invention, unless and until report recipient preferences are stored in the rule database 208, the rule data can comprise pre-set standard designations.

For example, the internal rules for the operation of an exemplary embodiment of the invention can comprise: (1) rules defining how each component of the system 100 interacts, including, e.g., the type, amount, and form of data to transfer from one component of the system 100 to another component of the system 100 for the system 100 to function properly; (2) rules defining how to obtain claim data; and/or (3) rules defining, for each claim data source, the type and form of data required to obtain the claim data.

In one embodiment of the invention, the agent(s) of the insurance carrier(s) can store the rule data in the rule database 208. For example, the agent(s) can access the rule database 208 via the terminal 155.

The term “claim data” is used herein to refer to information regarding the loss history of one or more insurance claims. For example, the claim data can comprise: (1) each claim's claim type (e.g., whether the claim is a bodily injury, property damage, collision, catastrophe, and/or comprehensive claim); (2) the amount of money paid for each claim (i.e., the claim loss amount); (3) the name, address, and/or driver's license number of the policy holder corresponding to each claim; (4) the vehicle identification number of each vehicle, if any, corresponding to each claim; (5) the name, address, and/or driver's license number of the vehicle operator, if any, corresponding to each claim; (6) the policy number of the insurance policy corresponding to each claim; (7) the A.M. Best number of the insurance carrier corresponding to each claim; (8) an “at fault indicator” indicating whether the insured person corresponding to each claim was “at fault” in the activity that prompted the claim; (9) the date on which each claim was filed with the corresponding insurance carrier; and/or (10) the date on which the claim data corresponding to the claim was stored in a claim database 140.

The claim data is stored in the claim database 140. In one embodiment of the invention, the agent(s) of the insurance carrier(s) can store the claim data in the claim database 140. For example, the agent(s) can access the claim database 140 via the terminal 155.

Storage of the policy data, the insured data, the rule data, and the claim data in the policy database 110, the insured database 120, the rule database 208, and the claim database 140, respectively, enables system components to utilize available information about an insurance carrier's preferences, insurance policies, and insured persons to automatically and continuously generate and output customized reports based on insurance claim records of the insured persons.

In addition to the rule database 208, the control module 105 comprises a scheduling module 206, a reporting module 207, and a report database 227. The scheduling module 206 signals the reporting module 207 to generate and output reports at designated times. For example, the times can be designated in the rule data. Integration with the other system components, including without limitation the insured database 120, the policy database 110, the rule database 208, and the claim database 140, enables the scheduling module 206 to ensure that it signals the reporting module 207 for action at appropriate times.

When signaled by the scheduling module 206 to generate a report, the reporting module 207 submits certain policy data, insured data, and rule data to the claim monitoring module 135 for report generation. The claim monitoring module 135 is operable to generate claim monitoring reports. A claim monitoring report is a report based on the insurance claim records of one or more insured persons. For example the claim monitoring report can comprise information regarding whether any previously-unavailable claim information corresponds to an insured person and/or an insurance policy of an insured person. To obtain such information, the claim monitoring report can communicate with the claim database 140 to obtain claim data corresponding to the insured person and/or the insurance policy.

Upon report generation, the reporting module 207 can output the report and/or store the report in a report database 227. The term “output” is used herein to refer to any form of display or transmission. For example, the reporting module 207 can output the report by communicating a digital copy of the report to a display or a data storage device of a terminal 155. In one embodiment of the invention, the reporting module 207 can communicate an email message comprising the report to a report recipient. Alternatively, the reporting module 207 can output the report by printing the report onto paper.

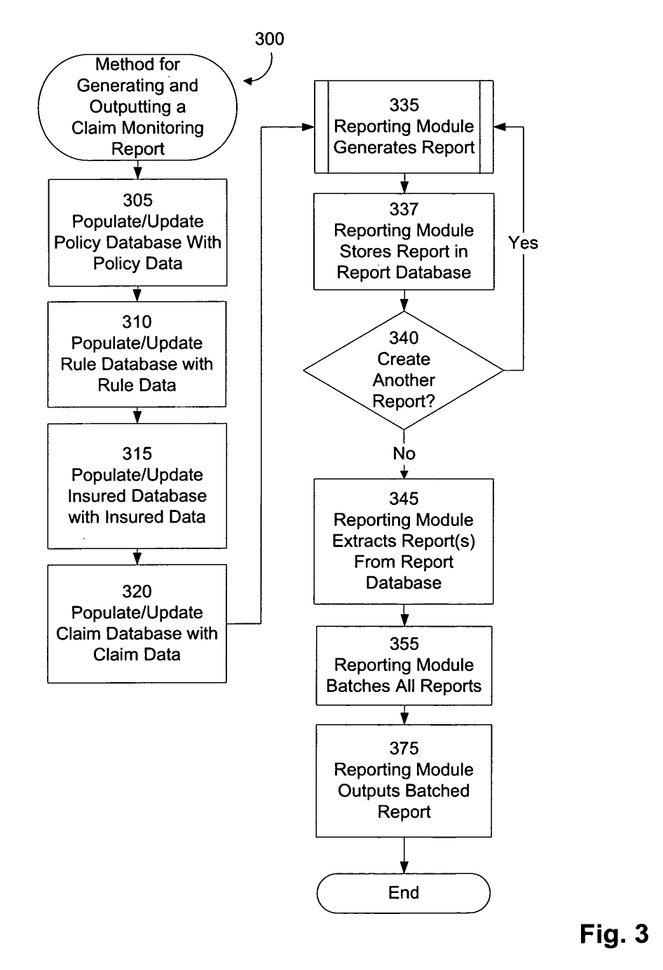

FIG. 3 is a flow chart depicting a method 300 for generating and outputting customized reports based on the insurance claim records of insured persons, according to an exemplary embodiment of the invention. The exemplary method 300 is illustrative and, in alternative embodiments of the invention, certain steps can be performed in a different order, in parallel with one another, or omitted entirely, and/or certain additional steps can be performed without departing from the scope and spirit of the invention. The method 300 is described below with reference to FIGS. 1-3.

In step 305, the policy database 110 is populated and/or updated with policy data. For example, at least one insurance carrier and/or an agent or agents of the insurance carrier(s) can populate and/or update the policy database 110 via a terminal 155 or an alternative data transfer means known in the art.

In step 310, the rule database 208 is populated and/or updated with rule data. For example, the agent(s) of the insurance carrier(s) can populate and/or update the rule database 208 via a terminal 155 or an alternative data transfer means known in the art.

In step 315, the insured database 120 is populated and/or updated with insured data. For example, the insurance carrier(s) and/or agent(s) can populate and/or update the insured database 120 via a terminal 155 or an alternative data transfer means known in the art.

In step 320, the claim database 140 is populated and/or updated with claim data. For example, the agent(s) can populate and/or update the claim database 140 via a terminal 155 or an alternative data transfer means known in the art.

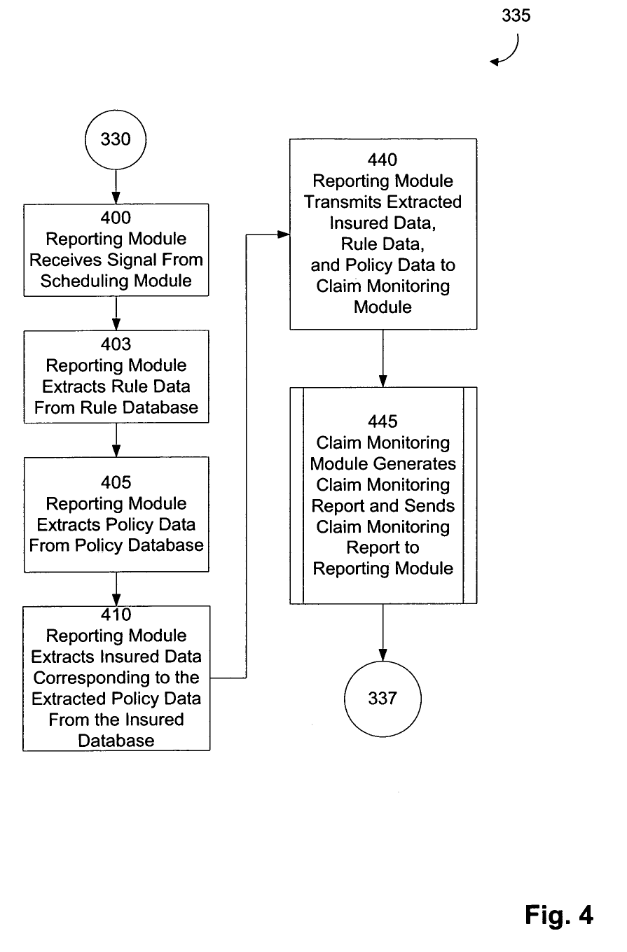

In step 335, the reporting module 207 generates a report. For example, the report can be a claim monitoring report. Step 335 is discussed in more detail below with reference to FIG. 4. The reporting module 207 stores the generated report in the report database 227 in step 337.

In step 340, the reporting module 207 determines whether to generate another report. If so, the method 300 branches back to step 335 to repeat the generation and storage of another report. If the reporting module 207 will not generate another report, then the method 300 branches to step 345.

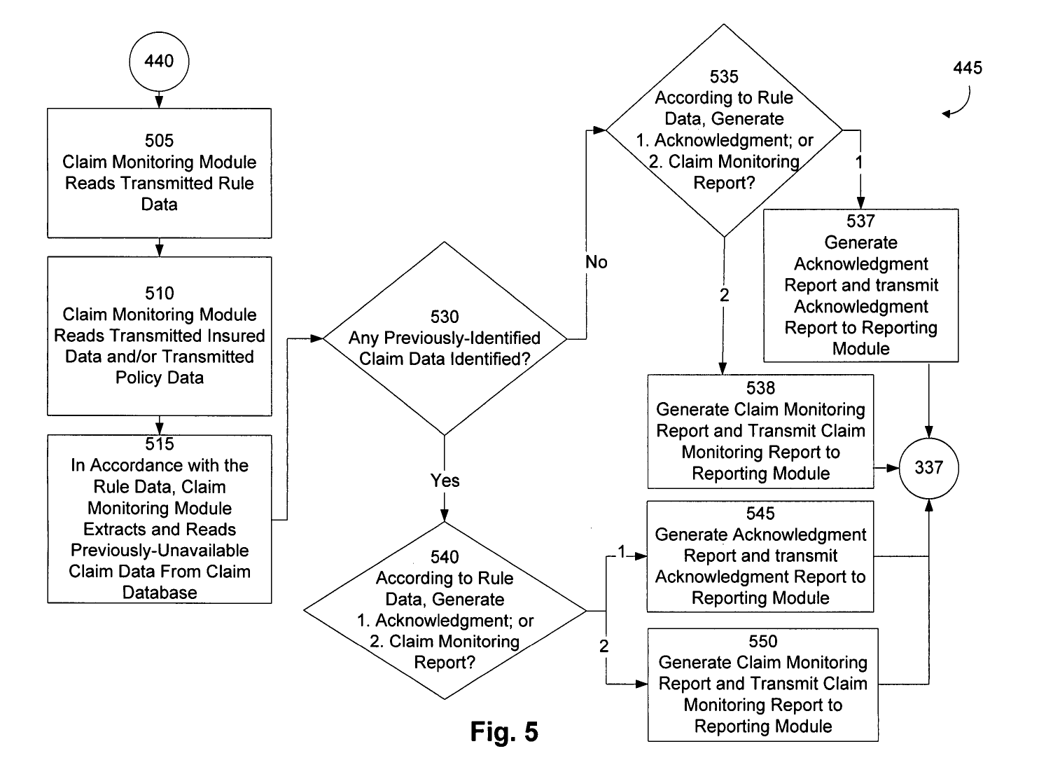

In step 345, the reporting module 207 extracts certain of the generated report(s) from the report database 227. For example, the reporting module 207 can extract non-acknowledgment reports from the report database 227. As described below with reference to step 537 of FIG. 5, an acknowledgment report is a report for internal system purposes only. An acknowledgment report will not be outputted to a report recipient.

In step 355, the reporting module 207 batches the extracted report(s) together for output. As used herein, the term “batch” refers to grouping and/or combining together one or more reports. For example, batching can comprise combining verbatim copies of each report into one “master” report. Alternatively, batching can comprise parsing and combining portions of each report to create a single, comprehensive report. The rule data determines the format and content of the batched report.

In step 375, the reporting module 207 outputs the batched report. For example, the reporting module 207 can output the report by communicating a digital copy of the report to a display or a data storage device of a terminal 155. In one embodiment of the invention, the reporting module 207 can communicate an email message comprising the report to a report recipient. Alternatively, the reporting module 207 can output the report by printing the report onto paper.

FIG. 4 is a flow chart depicting a method 335 for generating a report based on the insurance claim record of an insured person, according to an exemplary embodiment of the invention, as referred to in step 335 of FIG. 3. The exemplary method 335 is illustrative and, in alternative embodiments of the invention, certain steps can be performed in a different order, in parallel with one another, or omitted entirely, and/or certain additional steps can be performed without departing from the scope and spirit of the invention. The method 335 is described below with reference to FIGS. 1, 2, and 4.

In step 400, the reporting module 207 receives a signal from the scheduling module 206. The signal comprises instructions to the reporting module 207 to generate a report for a report recipient. For example, the report recipient can be an insurance carrier and/or an agent of the insurance carrier.

In step 403, the reporting module 207 extracts rule data from the rule database 208. The rule data comprises information regarding the report recipient's preferences, and internal rules, for the generation and output of the report. By accessing the rule data, the reporting module 207 can ensure that, in generating and outputting the report, it follows appropriate system protocol and generates and outputs the report in compliance with the report recipient's designated preferences.

In accordance with the rule data, the reporting module 207 extracts certain of an insurance carrier's policy data from the policy database 110 in step 405. For example, where the rule data comprises the report recipient's preference to base the report on the insurance claim records of insured persons who are insured by a particular insurance carrier and who reside in the state of New York, the reporting module 207 can extract all of the particular insurance carrier's insurance policy data. As another example, where the rule data comprises the report recipient's preference to base the report on the insurance claim records of insured persons who are insured by a particular insurance carrier on insurance policies that were executed during a specified time period, the reporting module 207 can extract the particular insurance carrier's insurance policy data corresponding to insurance policies that were executed during the specified time period.

The extracted policy data comprises information regarding at least one insurance policy. In particular, the policy data comprises information identifying the person(s) insured on each insurance policy. For example, the policy data can comprise a PIN number corresponding to insured data related to each insured person.

In step 410, in accordance with the rule data, the reporting module 207 extracts insured data from the insured database 120. The insured data corresponds to the policy data extracted in step 405. The insured data comprises information regarding each insured person insured on the insurance policy(ies) about which the extracted policy data relates.

As set forth above, where the rule data comprises the report recipient's preference to base the report on the insurance claim records of insured persons who are insured by a particular insurance carrier and who reside in the state of New York, the reporting module 207 can extract all of the particular insurance carrier's insurance policy data in step 405. In step 410, the reporting module can extract insured data corresponding to each insured person living in New York who is insured on an insurance policy of the particular insurance carrier.

In one embodiment of the invention, the reporting module 207 can generate a report without extracting insured data. For example, if the report will not comprise insured data and if the rule data designates a particular insurance policy about which to generate a report, the reporting module 207 can generate the report without extracting both policy data and insured data.

In step 415, the reporting module 207 transmits the extracted insured data, rule data, and policy data to the claim monitoring module 135 for report generation. In step 445, the claim monitoring module 135 generates a claim monitoring report and transmits the generated report to the reporting module 207. Step 445 is discussed in more detail below with reference to FIG. 5. Once the claim monitoring module 135 generates the claim monitoring report and transmits the generated report to the reporting module 207, the method 335 branches to step 337 (FIG. 3).

FIG. 5 is a flow chart depicting a method 445 for generating a claim monitoring report, according to an exemplary embodiment of the invention, as referred to in step 445 of FIG. 4. The exemplary method 445 is illustrative and, in alternative embodiments of the invention, certain steps can be performed in a different order, in parallel with one another, or omitted entirely, and/or certain additional steps can be performed without departing from the scope and spirit of the invention. The method 445 is described below with reference to FIGS. 1, 2, 4, and 5.

In step 505, the claim monitoring module 135 reads the rule data transmitted to it from the reporting module 207 in step 415. In step 510, the claim monitoring module 135 reads the insured data and/or the policy data transmitted to it from the reporting module 207 in step 415. In accordance with the rule data, the claim monitoring module 135 extracts and reads previously-unavailable claim data from the claim database 140 in step 515.

Following the example set forth above, if the rule data indicates the report recipient's preference to base the report on the insurance claim records of insured persons who are insured by a particular insurance carrier and who reside in the state of New York, the claim monitoring module 135 can extract and read claim data corresponding to each insured person about whom the insured data read in step 510 relates. For example, to extract and read the correct claim data, the claim monitoring module 135 can compare the name of each policy holder corresponding to each claim to the name of each insured person. If the names match, the claim monitoring module 135 can extract and read the claim data. In certain embodiments of the invention, the claim monitoring module 135 can extract and read the claim data even if the match between the claim data and the insured data is not exact. For example, the claim monitoring module 135 can extract and read the claim data if, according to the rule data, the match is sufficiently close as to be a possible or likely match.

In addition, in accordance with the rule data, the claim monitoring module 135 can limit its extraction and reading of claim data based on characteristics of the claim data. For example, if the rule data indicates a preference to provide information only about certain types of claims or certain claim loss amounts, the claim monitoring module 135 can extract and read only claim data regarding the designated claim types or loss amounts. In addition, in accordance with the rule data, the claim monitoring module 135 can limit its extraction and reading of claim data only to claim data for which the at fault indicator indicates that the insured person corresponding to each claim was at fault in the activity that prompted the claim.

Depending on the rule data, the claim monitoring module 135 can limit extraction and reading only to claim data saved in the claim database 140 within a certain time period. For example, the claim monitoring module 135 can limit extraction and reading only to claim data updated to the claim database 140 thirty (30) days prior up to 120 days after each insurance policy's insurance policy inception date.

By so limiting the claim data extraction and reading, the claim monitoring module 135 can limit the extracted and read claim data to previously-unavailable claim data. For example, the claim data can comprise information saved to the claim database 140 after (or a designated time before) the insurance carrier executed an insurance policy with an insured person about whom the claim data relates. Such claim data was unavailable to the insurance carrier at the time of execution.

State laws generally provide that, after entering into an insurance policy with a new customer, an insurance carrier has a short period in which to cancel the policy or change the terms of the policy based on newly-discovered information. The claim monitoring module 135 can limit the extracted and read claim data to information saved in the claim database 140 during the state-law defined review period. Thus, the extracted and read claim data will comprise information regarding previously-unavailable claim data for which the insurance carrier can cancel the corresponding insurance policy or change the terms of the corresponding policy.

In step 530, the claim monitoring module 135 determines whether it identified any previously-unavailable claim data. If not, the method 445 branches to step 535.

In step 535, the claim monitoring module 135 determines whether, according to the rule data, it will generate an acknowledgment report or a claim monitoring report. An acknowledgment report is a report comprising an acknowledgment that the claim monitoring module 135 failed to obtain any pertinent information. For example, the claim monitoring module 135 can generate an acknowledgment report when the rule data indicates a preference of the report recipient not to receive a report unless pertinent information (i.e., information identifying previously-unavailable claim data) is obtained. Because the acknowledgment report is a record of non-report-outputting work performed by the claim monitoring module 135, the acknowledgment report can serve as a record by which the performance of the claim monitoring module 135 can be monitored.

If the claim monitoring module 135 determines in step 535 to generate an acknowledgment report, the method 445 branches to step 537. In step 537, the claim monitoring module 135 generates the acknowledgment report and transmits the acknowledgment report to the reporting module 207. The rule data dictates the format and content of the acknowledgment report. For example, the acknowledgment report can comprise rule data, policy data, insured data, and/or claim data. Upon completion of step 537, the method 445 branches to step 337 (FIG. 3).

If the claim monitoring module 135 determines in step 535 to generate a claim monitoring report, the method 445 branches to step 538. In step 538, the claim monitoring module 135 generates the claim monitoring report and transmits the claim monitoring report to the reporting module 207. For example, the claim monitoring report can inform the report recipient that the claim monitoring module 135 failed to obtain any pertinent information. The rule data dictates the format and content of the claim monitoring report. For example, the claim monitoring report can comprise rule data, policy data, insured data, and/or claim data. Upon completion of step 538, the method 445 branches to step 337 (FIG. 3).

If the claim monitoring module 135 determines in step 530 that it identified previously-identified claim data, the method 445 branches to step 540. In step 540, the claim monitoring module 135 determines whether, according to the rule data, it will generate an acknowledgment report or a claim monitoring report. For example, the rule data can indicate that, depending on the claim data identified in step 525, the claim monitoring module 135 should generate an acknowledgment report. For example, the rule data can designate that an acknowledgment report should be generated if the claim data relates to a claim with a negative at fault indicator.

If the claim monitoring module 135 determines in step 540 to generate an acknowledgment report, the method 445 branches to step 545. In step 545, the claim monitoring module 135 generates the acknowledgment report and transmits the acknowledgment report to the reporting module 207. The rule data dictates the format and content of the acknowledgment report. For example, the acknowledgment report can comprise rule data, policy data, insured data, and/or claim data. Upon completion of step 545, the method 445 branches to step 337 (FIG. 3).

If the claim monitoring module 135 determines in step 540 to generate a claim monitoring report, the method 445 branches to step 550. In step 550, the claim monitoring module 135 generates the claim monitoring report and transmits the claim monitoring report to the reporting module 207. For example, the claim monitoring report can inform the report recipient of the claim data identified in step 525. The rule data dictates the format and content of the claim monitoring report. For example, the claim monitoring report can comprise rule data, policy data, insured data, and/or claim data. Upon completion of step 550, the method 445 branches to step 337 (FIG. 3).

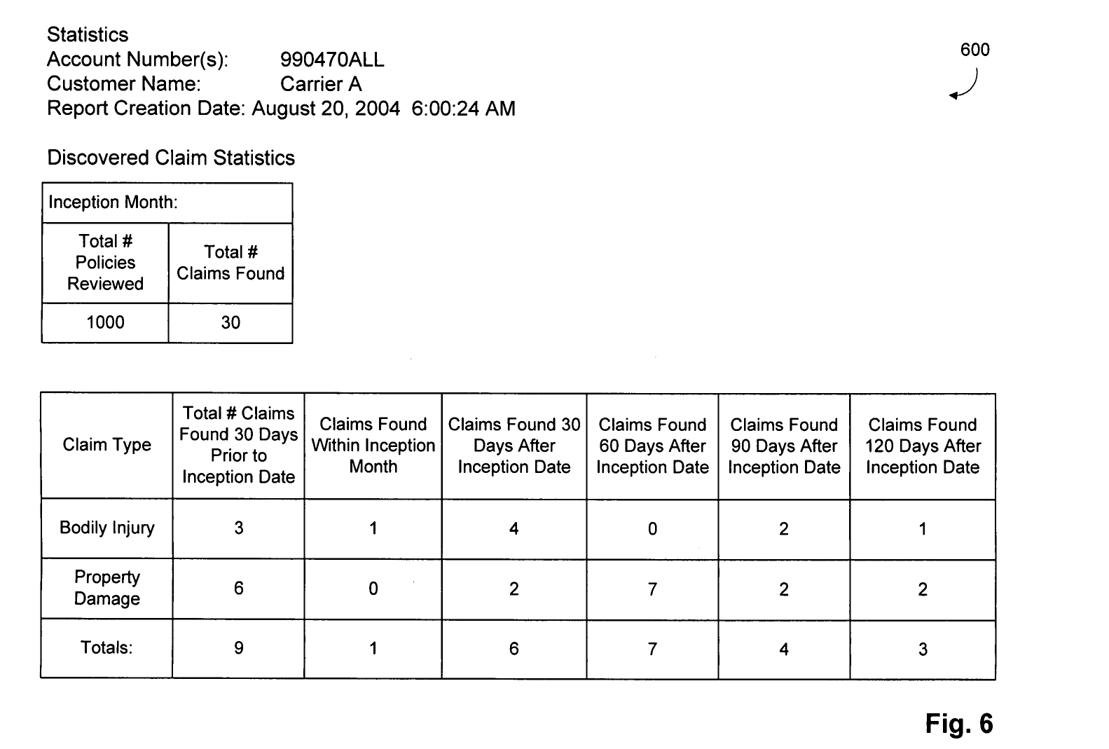

FIG. 6 is a block diagram depicting a claim monitoring report 600 generated in accordance with an exemplary embodiment of the invention. The report 600 is merely illustrative and, in alternative embodiments of the invention, certain elements of the report 600 can be altered; certain elements can be omitted entirely; and/or certain additional elements can be included.

The report 600 comprises information regarding newly-discovered claim data. Of 1000 total insurance policies reviewed, claim data regarding thirty (30) newly-discovered claims were found. Each discovered claim corresponds to an insurance policy of an insurance carrier. Of the thirty (30) claims, claim data regarding nine (9) of the claims was uploaded to the claim database 140 prior to the inception date of the claims' corresponding policy(ies); claim data regarding one (1) of the claims was uploaded within a month of the inception date of the claim's corresponding policy(ies); claim data regarding six (6) of the claims was uploaded within thirty (30) days after the inception date of the claims' corresponding policy(ies); claim data regarding seven (7) of the claims was uploaded within sixty (60) days after the inception date of the claims' corresponding policy(ies); claim data regarding four (4) of the claims was uploaded within thirty (30) days after the inception date of the claims' corresponding policy(ies); and claim data regarding three (3) of the claims was uploaded within 120 days after the inception date of the claims' corresponding policy(ies).

The present invention can be used with computer hardware and software that performs the methods and processing functions described above. As will be appreciated by a person of skill in the art, the systems, methods, and procedures described herein can be embodied in a programmable computer, computer executable software, or digital circuitry. The software can be stored on computer readable media. For example, computer readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

Although specific embodiments of the present invention have been described above in detail, the description is merely for purposes of illustration. It should be appreciated, therefore, that many aspects of the invention were described above by way of example only and are not intended as required or essential elements of the invention unless explicitly stated otherwise. Various modifications of, and equivalent steps corresponding to, the disclosed aspects of the exemplary embodiments, in addition to those described above, can be made by those skilled in the art without departing from the spirit and scope of the present invention defined in the following claims, the scope of which is to be accorded the broadest interpretation so as to encompass such modifications and equivalent structures.

We claim:

1. A computer-implemented method for identifying previously-unavailable claim data corresponding to an insured person insured on an insurance policy of an insurance carrier, comprising the steps of:
creating claim data comprising information regarding at least one insurance claim;
identifying any of the claim data that corresponds to the insured person by comparing the claim data to at least one of policy data and insured data, the policy data comprising information regarding at least one insurance policy of the insurance carrier, the insured data comprising, for each insurance policy, information regarding at least one person insured on the insurance policy; and
determining whether the identified claim data was unavailable to the insurance carrier during a specified time period comprising an execution date of an insurance policy corresponding to the insured person and the insurance carrier.

2. The computer-implemented method of claim 1, wherein the step of determining whether the identified claim data was unavailable to the insurance carrier during the specified time period comprises the steps of:
identifying policy data corresponding to the insurance carrier and the insured person;
determining an execution date of an insurance policy corresponding to the identified policy data;
determining a date on which the identified claim data was created; and
determining whether the date on which the identified claim data was created is within a specified number of days of the execution date of the insurance policy corresponding to the identified policy data.

3. The computer-implemented method of claim 1, wherein the claim data comprises, for each insurance claim, at least one of a claim type, a claim loss amount, a name of an insured person corresponding to the claim, and a date on which the claim data corresponding to the claim was created.

4. The computer-implemented method of claim 1, wherein the step of creating the claim data comprises the steps of:
obtaining the claim data from a claim data source; and
storing the claim data in a claim database.

5. The computer-implemented method of claim 1, further comprising the step of generating a report comprising information regarding whether the identified claim data was unavailable to the insurance carrier during the specified time period.

6. The computer-implemented method of claim 5, further comprising the step of creating rule data designating at least one of the format of the report and the content of the report, wherein the step of generating the report comprises applying the rule data to at least one of the policy data, insured data, and claim data.

7. A computer-implemented method for generating a report based on whether previously-unavailable claim data corresponds to an insured person insured on an insurance policy of an insurance carrier, comprising the steps of:
creating claim data comprising information regarding at least one insurance claim;
identifying any of the claim data that corresponds to the insured person by comparing the claim data to at least one of policy data and insured data, the policy data comprising information regarding at least one insurance policy of the insurance carrier, the insured data comprising, for each insurance policy, information regarding at least one person insured on the insurance policy;
determining whether the identified claim data was unavailable to the insurance carrier during a specified time period comprising an execution date of an insurance policy corresponding to the insured person and the insurance carrier; and
generating a report in accordance with rule data comprising a formatting designation designating at least one of the format of the report and the content of the report, the formatting designation based on whether the identified claim data was unavailable to the insurance carrier during the specified time period.

8. The computer-implemented method of claim 7, wherein the step of determining whether the identified claim data was unavailable to the insurance carrier during the specified time period comprises the steps of:
identifying policy data corresponding to the insurance carrier and the insured person;
determining an execution date of an insurance policy corresponding to the identified policy data;
determining a date on which the identified claim data was created; and
determining whether the date on which the identified claim data was created is within a specified number of days of the execution date of the insurance policy corresponding to the identified policy data.

9. The computer-implemented method of claim 7, wherein the claim data comprises, for each insurance claim, at least one of a claim type, a claim loss amount, a name of an insured person corresponding to the claim, and a date on which the claim data corresponding to the claim was created.

10. The computer-implemented method of claim 7, wherein the step of creating the claim data comprises the steps of:
obtaining the claim data from a claim data source; and
storing the claim data in a claim database.

11. A computer-implemented method for identifying previously-unavailable claim data corresponding to an insured person insured on an auto insurance policy of an insurance carrier, comprising the steps of:
creating claim data comprising information regarding at least one auto insurance claim;
identifying any of the claim data that corresponds to the insured person by comparing the claim data to at least one of policy data and insured data, the policy data comprising information regarding at least one auto insurance policy of the insurance carrier, the insured data comprising, for each insurance policy, information regarding at least one person insured on the insurance policy; and
determining whether previously-unavailable claim data corresponds to the insured person by
identifying policy data corresponding to the insurance carrier and the insured person,
determining an execution date of an insurance policy corresponding to the identified policy data,
determining a date on which the identified claim data was created, and
determining whether the date on which the identified claim data was created is within a specified number of days of the execution date of the insurance policy corresponding to the identified policy data.

12. The computer-implemented method of claim 11, wherein the claim data comprises, for each insurance claim, at least one of a claim type, a claim loss amount, a name of an insured person corresponding to the claim, and a date on which the claim data corresponding to the claim was created.

13. The computer-implemented method of claim 11, wherein the step of creating the claim data comprises the steps of:
obtaining the claim data from a claim data source; and
storing the claim data in a claim database.

14. The computer-implemented method of claim 11, further comprising the step of generating a report comprising information regarding whether previously-unavailable claim data corresponds to the insured person.

15. The computer-implemented method of claim 14, further comprising the step of creating rule data designating at least one of the format of the report and the content of the report, wherein the step of generating the report comprises applying the rule data to at least one of the policy data, insured data, and claim data.
